(19) United States
(12) Patent Application Publication
(10) Pub. No.: US 2021/0312256 A1
(43) Pub. Date: Oct. 7, 2021

(54) Systems and Methods for Electronic Marketing Communications Review

(71) Applicant: FMR LLC, Boston, MA (US)

(72) Inventors: John Mariano, Boston, MA (US); Norman Ashkenas, Boston, MA (US); Todd Whiteley, Boston, MA (US); Sathish Kumar Chellan, Boston, MA (US); James Vishka, Boston, MA (US); John Lajiness, Boston, MA (US); Douglas Ward, Boston, MA (US)

(21) Appl. No.: 17/221,410

(22) Filed: Apr. 2, 2021

Related U.S. Application Data
(60) Provisional application No. 63/005,058, filed on Apr. 3, 2020.

(51) Int. Cl. G06N 3/02; G06F 16/248

(52) U.S. Cl. CPC G06N 3/02; G06F 16/248

(57) ABSTRACT

Systems and methods for tagging data strings in electronic documents using a convolutional neural network model. The method includes receiving an electronic document and extracting data strings from the electronic document. The method also includes tokenizing each of the data strings into tokens and determining a first tag corresponding to a first token for a first data string using a convolutional neural network model. The method further includes receiving user response data corresponding to an accuracy of the first tag and determining a second tag corresponding to the first token based on the user response data using the convolutional neural network model. The method also includes storing results data into a database and generating for display the results data on a user device.

### CROSS REFERENCE TO RELATED APPLICATIONS

This application claims the benefit of and priority to U.S. Provisional Patent Application No. 63/005,058, filed Apr. 3, 2020, the entire contents of which are owned by the assignee of the instant application and incorporated herein by reference in their entirety.

### FIELD OF THE INVENTION

The present invention relates generally to systems and methods for extracting data strings from electronic documents, including systems and methods for tagging extracted data strings.

### BACKGROUND OF THE INVENTION

The Financial Industry Regulatory Authority (“FINRA”) Rule 2210 and Securities and Exchange Commission (SEC) Rule 206(4)-1 govern Broker Dealer and Investment Adviser communications with the public including communications with retail and institutional investors. These ‘rules’ provide standards for the content, approval, recordkeeping and filing of certain communications with FINRA. Firms, in general, must comply with the rules when communicating with the public. The rules require financial institutions to review and approve marketing materials to ensure that the language used does not bias or mislead a consumer. To ensure that the content created is consistent with the rules including that communications are fair, balanced, and not misleading, the firms should have an extensive review process.

Lapse in review could put firms in regulatory, reputation, litigation, and monetary risk. Unbalanced or misleading communications increase the risk that customers bring legal claims against firms for investment losses. Unfair comparisons increase the risk of competing firms requesting regulatory action against firms. Departure from the regulatory standards may result in regulatory censures, fines, and additional FINRA filing requirements.

However, today, content in marketing materials are manually reviewed to determine if they comply with FINRA rules. Automating the review process can decrease the review cycle time and increase accuracy of compliance determinations. Machine learning technology can assist scanning for language bias, with greater than 40% of the process automated, resulting in hundreds of hours saved or repurposed.

### SUMMARY OF THE INVENTION

Accordingly, an object of the invention is to provide systems and methods for tagging data strings in electronic documents. For example, it is an object of the invention to provide systems and methods for tagging data strings in electronic documents using a convolutional neural network model. It is an object of the invention to provide systems and methods for extracting data strings from electronic documents and tokenizing the data strings. It is an object of the invention to provide systems and methods for tagging data strings in electronic documents based on user response data and a convolutional neural network model.

In some aspects, a computerized method for tagging data strings in electronic documents using a convolutional neural network model includes receiving an electronic document including data strings. For example, in some embodiments, the electronic document includes marketing material corresponding to a financial institution. The method further includes extracting the data strings from the electronic document. The method also includes tokenizing each of the data strings into tokens. In some embodiments, each of the data strings are tokenized using natural language processing. For example, in some embodiments, each of the data strings are tokenized and lemmatization is applied with the result stored in a trained dataset dictionary.

Further, the method includes determining a first tag corresponding to a first token for a first data string using a convolutional neural network model. The method also includes receiving first user response data corresponding to the first tag. The first user response data corresponds to an accuracy of the first tag. The method further includes determining a second tag corresponding to the first token based on the first user response data using the convolutional neural network model. For example, in some embodiments, the first tag and the second tag are determined based on regulator rules. The method also includes storing results data into a database. The results data includes at least the second tag and the first token. In some embodiments, the results data can be used to train the convolutional neural network model over a period of time. Further, the method includes generating for display the results data on a user device.

In some aspects, a system for tagging data strings in electronic documents using a convolutional neural network model includes a server computing device communicatively coupled to a database and a user device. The server computing device is configured to receive an electronic document including data strings. The server computing device is also configured to extract the data strings from the electronic document. Further, the server computing device is configured to tokenize each of the data strings into tokens.

The server computing device is also configured to determine a first tag corresponding to a first token for a first data string using a convolutional neural network model. Further, the server computing device is configured to receive first user response data corresponding to the first tag. The first user response data corresponds to an accuracy of the first tag. The server computing device is also configured to determine a second tag corresponding to the first token based on the first user response data using the convolutional neural network model. Further, the server computing device is configured to store results data into a database and display the results data on the user device. The results data includes at least the second tag and the first token.

In some embodiments, the server computing device is configured to determine a replacement token corresponding to the first token. For example, in some embodiments, the server computing device is configured to generate for display the replacement token on the display device. In some embodiments, the server computing device is configured to receive second user response data corresponding to the replacement token. In some embodiments, the server computing device is configured to determine a third tag corresponding to the replacement token using the convolutional neural network model.

In some embodiments, the electronic document includes marketing materials corresponding to a financial institution. In some embodiments, the server computing device is configured to determine the first tag and the second tag based on regulatory rules.

In some embodiments, the server computing device is configured to tokenize each of the data strings using natural language processing. For example, in some embodiments, the server computing device is configured to tokenize each of the data strings using lemmatization. In some embodiments, the server computing device is configured to train the convolutional neural network model based on the results data over a period of time.

Other aspects and advantages of the invention can become apparent from the following drawings and description, all of which illustrate the principles of the invention, by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of an exemplary data communications network, according to embodiments of the technology described herein.

FIG. 2 is a block diagram of an exemplary server computing device and an exemplary user device, according to embodiments of the technology described herein.

FIG. 3 is a diagram of an eReview architecture for tagging data strings in electronic documents using a convolutional neural network model, according to embodiments of the technology described herein.

FIG. 4 is a flow diagram of a computer-implemented method for analyzing data strings using a convolutional neural network model, according to embodiments of the technology described herein.

FIG. 5 is a diagram showing a confusion matrix for calculating performance metrics of a convolutional neural network model, according to embodiments of the technology described herein.

FIG. 6 is a diagram showing a visualization of performance metrics for various models, according to embodiments of the technology described herein.

FIG. 7 is a diagram showing an exemplary data visualization of model results, according to embodiments of the technology described herein.

FIG. 8 is a flow diagram of a computer-implemented method for tagging data strings in electronic documents using a convolutional neural network model, according to embodiments of the technology described herein.

### DETAILED DESCRIPTION OF THE INVENTION

The systems and methods described herein can enable an integrated platform that facilitates legal risk oversight, and review of marketing and sales literature across all aspects of an institution. For example, in some aspects, the systems and methods described herein can include one or more mechanisms or methods for tagging data strings in electronic documents. The system and methods can include mechanisms or methods for tagging data strings in electronic documents using a convolutional neural network model. The systems and methods described herein can provide mechanisms or methods for extracting data strings from electronic documents and tokenizing the data strings. The systems and methods described herein can provide mechanisms or methods for tagging data strings in electronic documents based on user response data and a convolutional neural network model.

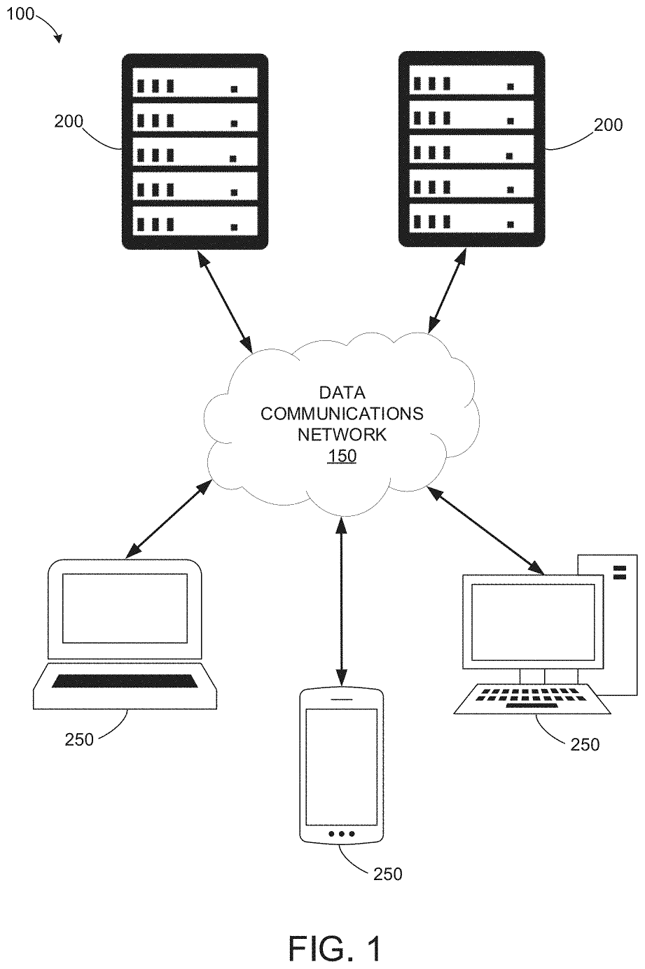

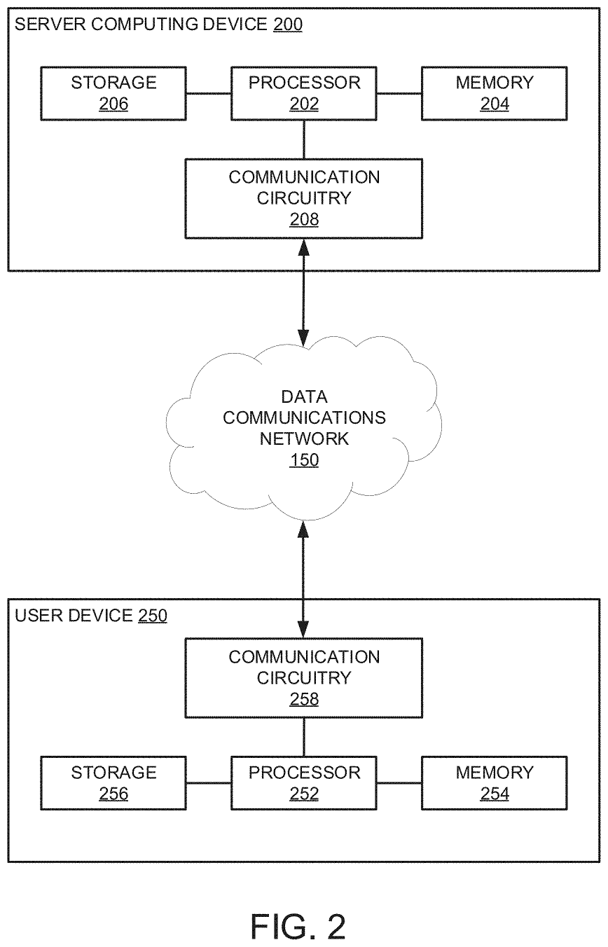

The systems and methods described herein can be implemented using a data communications network, server computing devices, and mobile devices. For example, referring to FIGS. 1 and 2, an exemplary communications system 100 includes data communications network 150, exemplary server computing devices 200, and exemplary user devices 250. In some embodiments, the system 100 includes one or more server computing devices 200 and one or more user devices 250. Each server computing device 200 can include a processor 202, memory 204, storage 206, and communication circuitry 208. Each user device 250 can include a processor 252, memory 254, storage 256, and communication circuitry 258. In some embodiments, communication circuitry 208 of the server computing devices 200 is communicatively coupled to the communication circuitry 258 of the user devices 250 via data communications network 150. Communication circuitry 208 and communication circuitry 258 can use Bluetooth, Wi-Fi, or any comparable data transfer connection. The user devices 250 can include personal workstations, laptops, tablets, mobile devices, or any other comparable device.

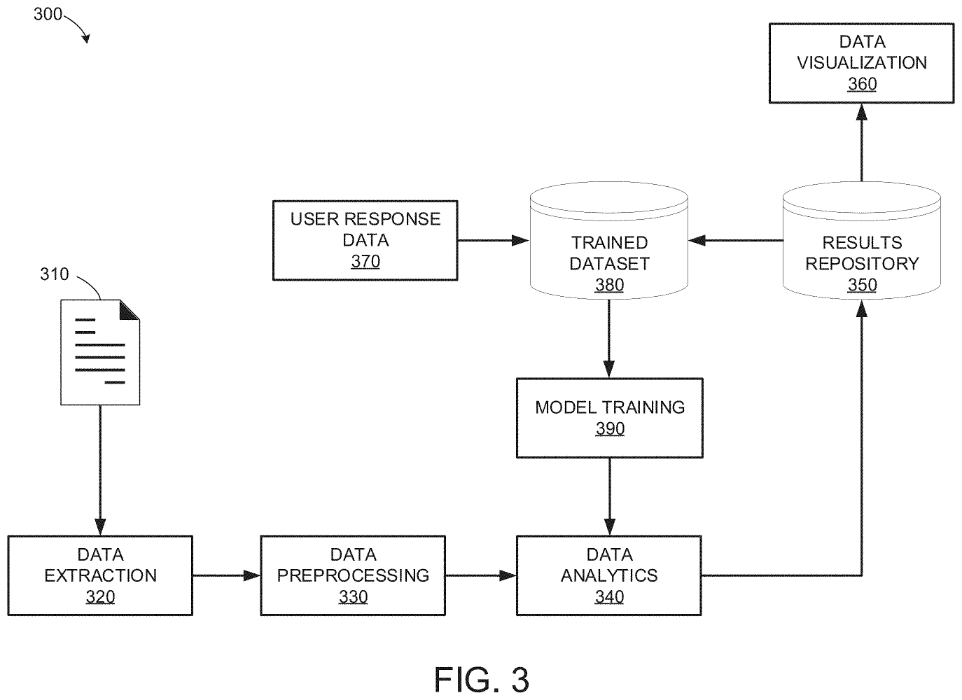

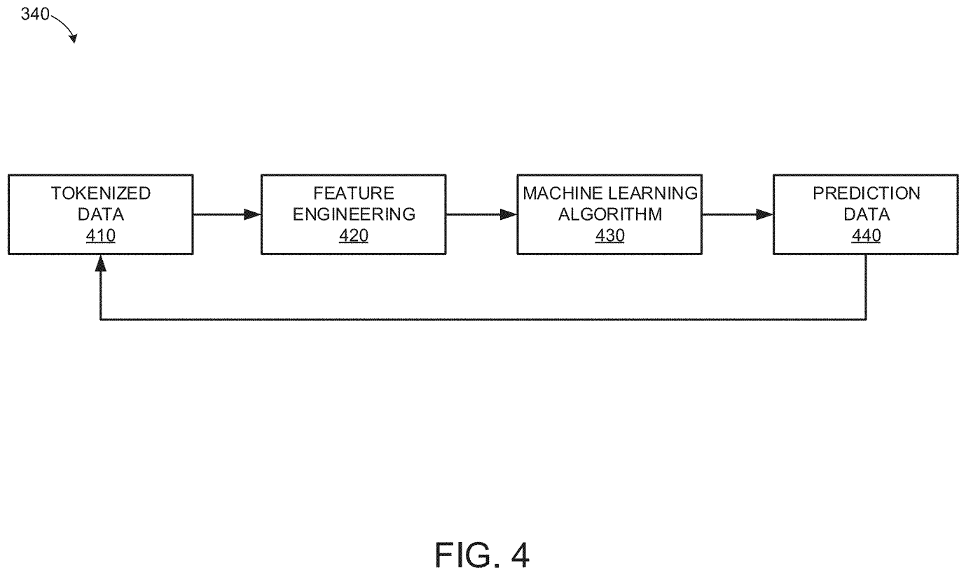

The systems and methods described herein allow for the integration of machine learning algorithms in the review process of marketing materials or other electronic documents. For example, referring to FIG. 3, an eReview architecture 300 is illustrated. Architecture 300 includes a data extraction module 320, a data preprocessing module 330, a data analytics module 340, and a data visualization module 360. Data analytics module 340 is described further below in relation to FIG. 4. The modules and other elements of eReview architecture 300 can be implemented using communications system 100.

Data extraction module 320 is configured to receive at least one electronic document 310 and extract one or more data strings from the electronic document 310. In some embodiments, electronic document 310 is a portable document format (PDF). For example, in some embodiments, the electronic document 310 includes marketing material corresponding to a financial institution. In some embodiments, data extraction module 320 can be implemented using a PDF parsing tool such as Python PDFMiner.

Once extracted, the data strings are tokenized using data preprocessing module 330. Tokenization is the process by which large quantities of text are divided into smaller segments called tokens. In some embodiments, data preprocessing module 330 is configured to tokenize each data string into tokens using natural language processing (NLP). For example, in some embodiments, data preprocessing module 330 is configured to tokenize each of the data strings using lemmatization. In some embodiments, data preprocessing module 330 can be implemented using a natural language toolkit (NLTK) such as NLTK with Python.

Once extracted and tokenized, the data strings are fed into a convolutional neural network model, implemented by data analytics module 340. As shown in FIG. 4, data analytics module 340 receives tokenized data 410 from data preprocessing module 330 and performs feature engineering 420 before applying a machine learning algorithm 430 to generate prediction data 440. Feature engineering 420 identifies features of the tokenized data strings to be used by the machine learning algorithm 430. For example, feature engineering 420 can identify whether a token constitutes a word or one or more sentences, whether a token has already been approved as compliant or rejected as non-compliant, and whether a token has already been flagged as exaggerated, misleading, promissory, or any other flag.

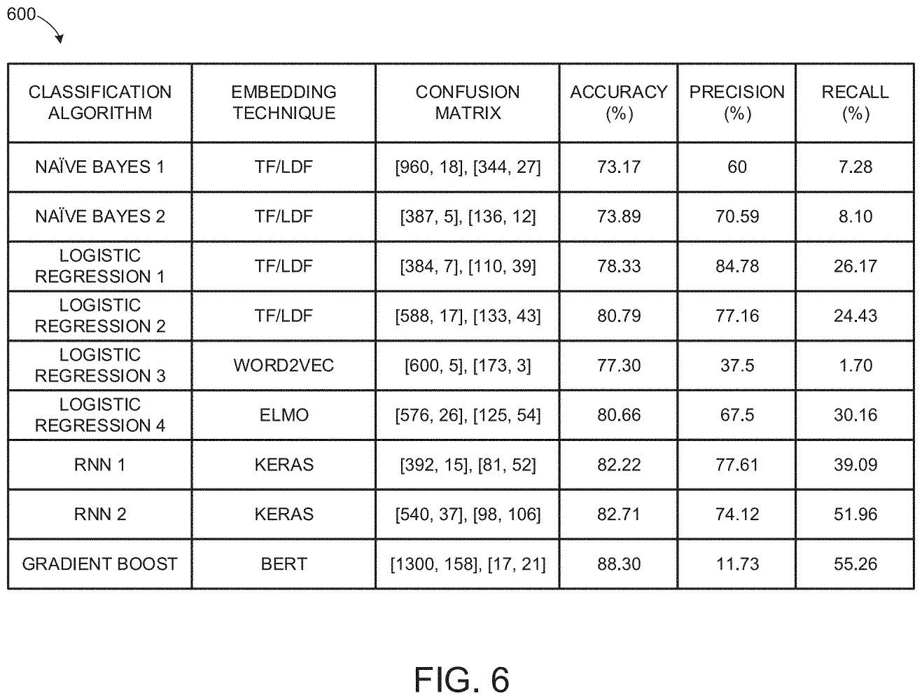

Using the tokenized data 410 and features engineering 420, machine learning algorithm 430 generates a function that maps an input to an output based on example input-output pairs. For example, machine learning algorithm 430 infers a function from labeled training data consisting of a set of training examples. Each example is a pair consisting of an input object and a desired output value. Machine learning algorithm 430 analyzes the training data and produces an inferred function, which can be used for generating prediction data 440. Example of models used for machine learning algorithm 430 are discussed further below in relation to FIG. 6.

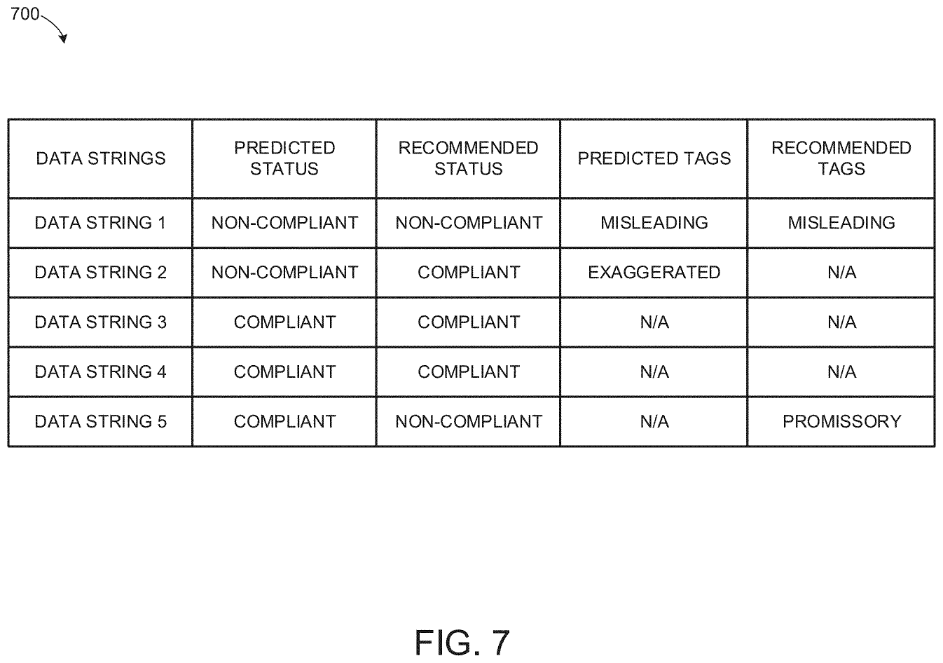

Referring to FIG. 3, the prediction data 440 generated by data analytics module 340 is stored in results repository 350 and compiled for visualization using data visualization module 360. An exemplary visualization is discussed further below in relation to FIG. 7. Architecture 300 includes a user response data module 370 which is configured to receive user response data corresponding to the accuracy of prediction data 440. For example, in some embodiments, user response data module 370 can be configured to receive user response data from a user device 250. Architecture 300 is configured to store trained dataset 380 based on user response data 370 and data from results repository 350. Trained dataset 380 can be used by model training module 390 to train machine learning algorithm 430.

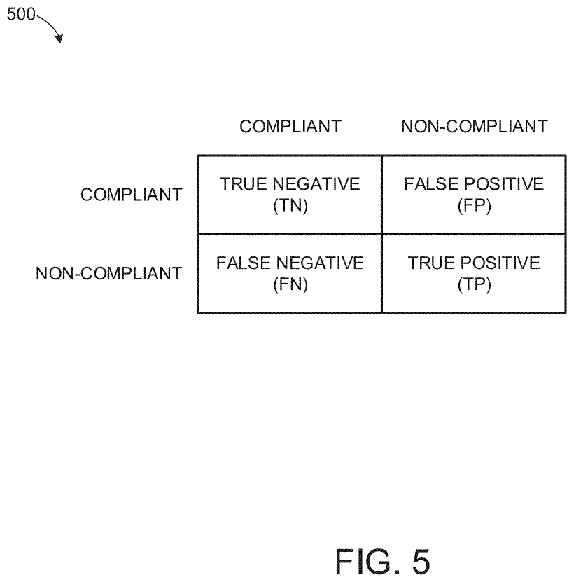

As shown in FIG. 5, confusion matrix 500 can be used in order to determine performance metrics of a particular model. After running the model for a number of data strings, the amount of true negatives (TN), false positives (FP), false negatives (FN), and true positives (TP) are stored in confusion matrix 500. For example, precision is defined as TP/(TP+FP), recall is defined as TP/(TP+FN), and accuracy is defined as (TP+TN)/(TP+TN+FP+FN). Examples of models and corresponding performance metrics are illustrated in FIG. 6. In some embodiments, a combination of model types can be used to provide the best results for a particular electronic document 310.

Referring to FIG. 7, an exemplary visualization 700 generated by data visualization module 360 is illustrated. As shown, visualization 700 includes one or more data strings, a predicted status of each data string, a recommended status of each data string, predicted tags of each data string, and recommended tags of each data string. For example, for each data string, data analytics module 340 can generate predicted data 440. Predicted data 440 can include a predicted status (compliant or non-compliant) and one or more predicted tags (e.g., misleading, exaggerated, and promissory). User response data 370 can include a recommended status and one or more recommended tags. As discussed in relation to FIGS. 3 and 4, user response data 370 can be used to create trained dataset 380 in order to train machine learning algorithm 430.

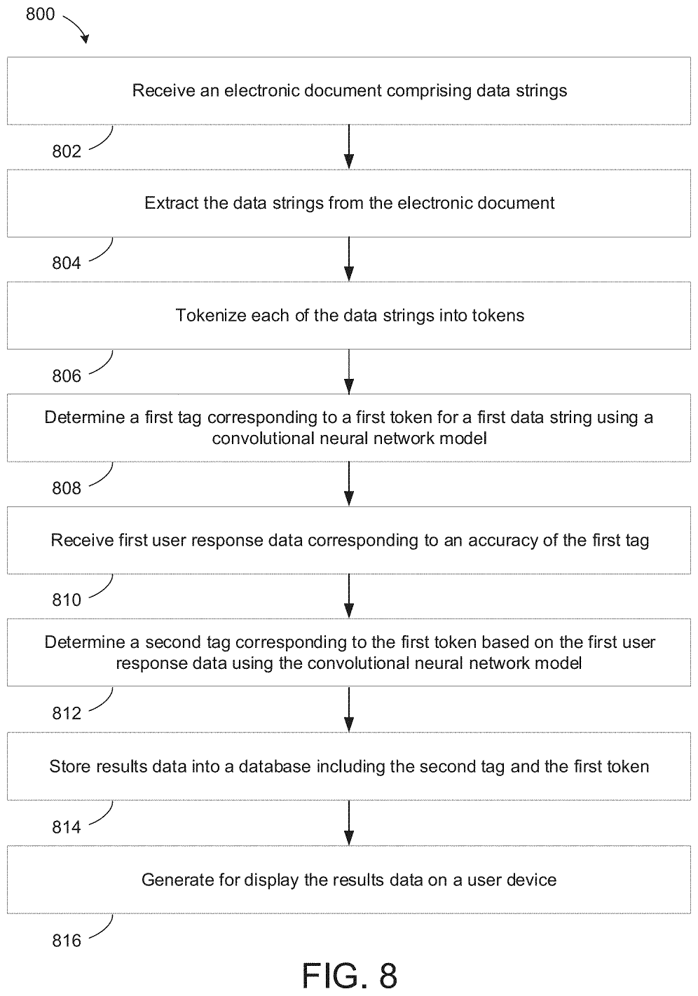

Referring to FIG. 8, a process 800 for tagging data strings in electronic documents 310 using communications system 100 is illustrated. The process 800 begins by receiving, by a server computing device 200, an electronic document 310 including data strings in step 802. For example, in some embodiments, the electronic document 310 includes marketing material corresponding to a financial institution. Process 800 continues by extracting, by the server computing device 200, the data strings from the electronic document 310 in step 804.

Process 800 continues by tokenizing, by the server computing device 200, each of the data strings into tokens in step 806. In some embodiments, the server computing device 200 is configured to tokenize each of the data strings using natural language processing. For example, in some embodiments, the server computing device 200 is configured to tokenize each of the data strings using lemmatization.

Process 800 continues by determining, by the server computing device 200, a first tag corresponding to a first token for a first data string using a convolutional neural network model in step 808. In some embodiments, the server computing device 200 is configured to determine the first tag corresponding to the first token for the first data string using two or more convolutional neural network models. Process 800 continues by receiving, by the server computing device 200, first user response data corresponding to the first tag in step 810. The first user response data corresponds to an accuracy of the first tag.

Process 800 continues by determining, by the server computing device 200, a second tag corresponding to the first token based on the first user response data using the convolutional neural network model in step 812. In some embodiments, the server computing device 200 is configured to determine the second tag corresponding to the first token using two or more convolutional neural network models. In some embodiments, the server computing device 200 is configured to determine the first tag and the second tag based on regulatory rules.

Process 800 continues by storing, by the server computing device 200, results data into a database in step 814. The results data includes at least the second tag and the first token. In some embodiments, the server computing device 200 is configured to train the convolutional neural network model based on the results data over a period of time. Process 800 finishes by generating, by the server computing device 200, for display the results data on a user device 250 in step 816.

In some embodiments, the server computing device 200 is configured to determine a replacement token corresponding to the first token. For example, in some embodiments, the server computing device 200 is configured to generate for display the replacement token on the user device 250. In some embodiments, the server computing device 200 is configured to receive second user response data corresponding to the replacement token. For example, in some embodiments, the server computing device 200 is configured to determine a third tag corresponding to the replacement token using the convolutional neural network model.

In some aspects, process 800 can be implemented on a system for tagging data strings in electronic documents 310 using a convolutional neural network model. The system includes a server computing device 200 communicatively coupled to a user device 250 and a database over a network 150. The server computing device 200 is configured to receive an electronic document 310 including data strings. For example, in some embodiments, the electronic document 310 includes marketing material corresponding to a financial institution.

The server computing device 200 is also configured to extract the data strings from the electronic document 310. Further, the server computing device 200 is configured to tokenize each of the data strings into tokens. In some embodiments, the server computing device 200 is configured to tokenize each of the data strings using natural language processing. For example, in some embodiments, the server computing device 200 is configured to tokenize each of the data strings using lemmatization.

The server computing device 200 is also configured to determine a first tag corresponding to a first token for a first data string using a convolutional neural network model. In some embodiments, the server computing device 200 is configured to determine the first tag corresponding to the first token for the first data string using two or more convolutional neural network models. Further, the server computing device 200 is configured to receive first user response data corresponding to the first tag. The first user response data corresponds to an accuracy of the first tag. The server computing device 200 is also configured to determine a second tag corresponding to the first token based on the first user response data using the convolutional neural network model. In some embodiments, the server computing device 200 is configured to determine the second tag corresponding to the first token using two or more convolutional neural network models. In some embodiments, the server computing device 200 is configured to determine the first tag and the second tag based on regulatory rules.

Further, the server computing device 200 is configured to store results data into a database. The results data includes at least the second tag and the first token. In some embodiments, the server computing device 200 is configured to train the convolutional neural network model based on the results data over a period of time. The server computing device 200 is further configured to generate for display the results data on a user device 250.

In some embodiments, the server computing device 200 is configured to determine a replacement token corresponding to the first token. For example, in some embodiments, the server computing device 200 is configured to generate for display the replacement token on the user device 250. In some embodiments, the server computing device 200 is configured to receive second user response data corresponding to the replacement token. For example, in some embodiments, the server computing device 200 is configured to determine a third tag corresponding to the replacement token using the convolutional neural network model.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The above-described techniques can be implemented using supervised learning and/or machine learning algorithms. Supervised learning is the machine learning task of learning a function that maps an input to an output based on example input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed:

1. A method for tagging data strings in electronic documents using a convolutional neural network model, the method comprising:
receiving, by a server computing device, an electronic document comprising at least a plurality of data strings;
extracting, by the server computing device, the plurality of data strings from the electronic document;
tokenizing, by the server computing device, each of the plurality of data strings into a plurality of tokens;
determining, by the server computing device, a first tag corresponding to a first token of the plurality of tokens for a first data string of the plurality of data strings using a convolutional neural network model;
receiving, by the server computing device, first user response data corresponding to the first tag, wherein the first user response data corresponds to an accuracy of the first tag;
determining, by the server computing device, a second tag corresponding to the first token based on the first user response data using the convolutional neural network model;
storing, by the server computing device, results data into a database, wherein the results data comprises at least the second tag and the first token; and
generating, by the server computing device, for display the results data on a user device.

2. The method of claim 1, wherein the server computing device is configured to determine a replacement token corresponding to the first token.

3. The method of claim 2, wherein the server computing device is configured to generate for display the replacement token.

4. The method of claim 3, wherein the server computing device is configured to receive second user response data corresponding to the replacement token.

5. The method of claim 4, wherein the server computing device is configured to determine a third tag corresponding to the replacement token using the convolutional neural network model.

6. The method of claim 1, wherein the electronic document comprises marketing material corresponding to a financial institution.

7. The method of claim 1, wherein the server computing device is configured to determine the first tag and the second tag based on regulatory rules.

8. The method of claim 1, wherein the server computing device is configured to tokenize each of the plurality of data strings using natural language processing.

9. The method of claim 8, wherein the server computing device is configured to tokenize each of the plurality of data strings using lemmatization.

10. The method of claim 1, wherein the server computing device is configured to train the convolutional neural network model based on the results data over a period of time.

11. A system for tagging data strings in electronic documents using a convolutional neural network model, the system comprising:
a server computing device communicatively coupled to a database and a user device, the server computing device configured to:
receive an electronic document comprising at least a plurality of data strings;
extract the plurality of data strings from the electronic document;
tokenize each of the plurality of data strings into a plurality of tokens;
determine a first tag corresponding to a first token of the plurality of tokens for a first data string of the plurality of data strings using a convolutional neural network model;
receive first user response data corresponding to the first tag, wherein the first user response data corresponds to an accuracy of the first tag;
determine a second tag corresponding to the first token based on the first user response data using the convolutional neural network model;
store results data into a database, wherein the results data comprises at least the second tag and the first token; and
generate for display the results data on the user device.

12. The system of claim 11, wherein the server computing device is configured to determine a replacement token corresponding to the first token.

13. The system of claim 12, wherein the server computing device is configured to generate for display the replacement token.

14. The system of claim 13, wherein the server computing device is configured to receive second user response data corresponding to the replacement token.

15. The system of claim 14, wherein the server computing device is configured to determine a third tag corresponding to the replacement token using the convolutional neural network model.

16. The system of claim 11, wherein the electronic document comprises marketing material corresponding to a financial institution.

17. The system of claim 11, wherein the server computing device is configured to determine the first tag and the second tag based on regulatory rules.

18. The system of claim 11, wherein the server computing device is configured to tokenize each of the plurality of data strings using natural language processing.

19. The system of claim 18, wherein the server computing device is configured to tokenize each of the plurality of data strings using lemmatization.

20. The system of claim 11, wherein the server computing device is configured to train the convolutional neural network model based on the results data over a period of time.
